(19) United States
(12) Patent Application Publication
(10) Pub. No.: US 2013/0014486 A1
(43) Pub. Date: Jan. 17, 2013

(54) Fiber laser powered thruster

(71) Applicant: Robert Neil Campbell, Corrales, NM (US)

(72) Inventor: Robert Neil Campbell, Corrales, NM (US)

(21) Appl. No.: 13/135,708

(22) Filed: Jul. 13, 2011

(51) Int. Cl. F03H 1/00

(52) U.S. Cl. 60/203.1

(57) ABSTRACT

A fiber laser powered, optical to thermal conversion thruster with improved practicality and operational and design flexibility.

### BACKGROUND OF INVENTION

1. Field of Invention

The present invention relates to the field of electrical propulsion thrusters, generally providing low thrust but high exhaust velocity and thus specific impulse, more specifically, a fiber laser powered, optical to thermal conversion thruster.

2. Description of Prior Art

U.S. Pat. No. 4,169,351 (Electrothermal thruster) describes an electrothermal thruster disclosure, wherein an electrical heater comprising a copper pipe surrounded by a co axial tubular copper jacket, and a resistance heated chamber cooperating to heat and decompose liquid fuel which flows into the pipe to effect a gaseous discharge through a propelling nozzle. The jacket has a closed end soldered to the pipe which is supported from the open end by wires. The pipe, jacket and wires constitute the secondary winding of a transformer. The primary winding is of toroidal form round an annular core disposed co axially about the pipe within the jacket. Induced current in the secondary causes heating of the pipe in turn heating fluid therein.

This is deficient in that as the thruster is directly electrically powered, in this case through thermal conversion by induction. It requires integral primary windings which, unless they are typically cryogenic, are lossy. In addition, this has a related mass contribution to thrust chamber. Furthermore, its prime power supply is ideally required to be within reasonable proximity to the thruster to limit transmission losses. This approach thus does not lend itself to the powering of multiple distributed thrusters located significantly remotely from a unitary prime power source.

U.S. Pat. No. 7,703,273 (Dual mode chemical electric thrusters for spacecraft) describes a spacecraft thruster disclosure, wherein dual mode operation, and a method of applying propulsion to a spacecraft using a dual mode thruster is provided. In one embodiment, the thrusters of the current invention can operate as a chemical motor to provide high thrust and low propellant exhaust velocity to achieve fast maneuverability, or as an electrical propulsion thruster to provide low thrust and high exhaust velocity to perform maneuvers with minimal amount of propellant.

This is deficient in that the thruster remains directly electrically powered. Its prime power should be in close proximity to thruster assembly to minimize transmission losses. It thus does not lend itself to powering of distributed thrusters at significantly remote locations from the prime power source.

U.S. Pat. No. 4,730,449 (Radiation transfer thrusters for low thrust applications) describes a thruster assembly disclosure which includes a removable filament in a heat exchange cavity which isolates propellant from the filament and transfers energy from the filament to the propellant. The filament may comprise a single winding of wire or may if desired comprise a bifilar wound helix. Also disclosed are a number of ways of powering the filament including a plurality of power supplies provided for redundancy as well as variability of operation. The thruster assembly housing includes sophisticated heat conduction structure including a tortuous internal heat conduction path which minimizes heat loss from the thruster for a variety of disclosed purposes. Also disclosed is structure for providing energy transfer to propellant both through radiation and emission. Also disclosed is structure for providing energy transfer to propellant both through radiation and emission. Further, a test bed facility for testing the inventive thruster assembly is set forth.

This is deficient in that the thruster remains directly electrically powered. Its prime power should be in close proximity to thruster assembly to minimize transmission losses. It is principally thermal band, incoherent, radiant transfer. It similarly is not suitable for the powering of multiple, remotely located relative to a prime power nexus, thrusters.

The paper titled Initial Design of a 1N Multi-Propellant Resistojet DUR-1, by Rycek, K. J. A. & Zandbergen, B T C and presented at the 2005 European Conference for Aerospace Sciences (EUCASS) in Paris, France describes the Delft University Resistojet-1 (DUR-1) that uses electrical energy to heat a gas to a high temperature after which the gas is expanded to supersonic velocity in a ‘De Laval’ nozzle. Heating takes place using the direct heating method. The heater is a coiled tube of small inner diameter. This allows a small size of the resistojet while still attaining high gas temperatures. This paper first gives a brief introduction to the need of non-chemical thermal propulsion systems as well as an overview of earlier resistojets and their characteristics. This is followed by a discussion of resistojet studies and analysis performed for DUR-1, focusing on electrical and heat transfer properties and thruster geometry. Next, the DUR-1 design is presented and discussed. Finally, some conclusions are drawn.

This is deficient in that the thruster remains directly electrically powered. Its prime power should be in close proximity to thruster assembly to minimize transmission losses. Again, this approach does not lend itself to the powering of multiple, remote relative to a central power node, distributed thrusters. The resistive element configuration is not well suited to unitary thrust chamber scaling.

The article, ATS-III Resistojet Thruster System Performance (T. Pugmire et al., Journal of Spacecraft and Rockets. Vol. 6, no. 7, 1969), describes an ATS 3 spacecraft ammonia-fueled resistojet engine test performance.

This is deficient in that the thruster remains directly electrically powered. Its prime power should be in close proximity to thruster assembly to minimize transmission losses. Again, this approach does not lend itself to the powering of multiple, remote relative to a central power node, distributed thrusters.

The preceding approaches, as electrothermal, electrothermal radiant (thermal band) transfer or simple resistojet thrusters, are all possessed of common deficiencies as a result of the essential features of the related electrical systems required and the fact that they utilize, in one form or another, electrically powered heating elements as an element of their thrust chambers. In order to minimize transmission losses the power supply must be in general in close proximity to the thruster assembly (thrust chamber) itself. High voltage and/or high current may be required, as may integral transformer arrangements be required for induction operated systems. Given issues of electrical insulation and power supply proximity and size then scaling to relatively high thrusts from a unitary thrust chamber is not straightforward at an engineering level. In addition, the ability to have a centralized power unit powering remote (kilometers or so distant) or distributed, multiple thrusters is clearly not feasible or remotely optimal.

Electrical transmission can be significantly improved by use of superconducting structures, but such comes with significant cost, mass, complexity and sustainability concerns. Specifically, typically some form of cryogenic support system is required as even high temperature superconductors operate at perhaps no more than 120K. Such structures would not easily, if at all, be able to be implemented as essentially freely moving tethers of significant extent. Finally, the mass issue related to any required system support structure is critical as it directly impacts overall system performance in its role as a thruster required to impart acceleration to itself and the object to which it is attached.

### SUMMARY OF THE INVENTION

The invention is comprised of high power laser diode pumped fiber lasers or directly diode laser arrays, which are efficient and can be located at a central power hub, their output coupled efficiently into fiber optics for transmission to one or more thrust chambers, where the fiber transmission line output is coupled into lossy hollow waveguides functioning as optical to thermal transducers internal to thrust chamber, at one or more removed or even remote locations, thus overcoming the shortcomings of prior art devices. The process is not, as far as hollow waveguide incident optical power is concerned, thermal radiation transfer, as thermal bands are less than ideal in terms of coupling to conductive metals; rather, optical wavelengths, typically near infrared, sub thermal band, are of interest. Similarly, thermal bands are currently not easily transmitted through fibers with any efficiency. Ultra short pulse (USP) interaction directly with working fluid may be considered, however dispersion of short pulse within any fiber delivery system would shackle said approach to similar conditions applying to direct electrical powering, namely in such case an USP laser would have to be in some proximity to the thruster it is powering.

Optical fibers transmit optical power with impressive efficiency over significant distances in their supported spectral bands. Optical fibers do not require cryogenic cooling.

As specified, the fiber optic output is delivered into lossy hollow waveguides (FIG. 1. A, B, D), typically Tungsten or Tantalum courtesy of their structural characteristics and melting (Tungsten ˜3695K, Tantalum ˜3290K) and weakening temperatures. The lossy hollow waveguides are in the form of hollow tubes of significantly greater length than diameter and would typically be cylindrical. Given their limited diameters they require relatively thin walls to resist crushing or buckling when exposed to external pressure.

The lossy hollow waveguides are positioned internal to thrust chamber, each with an optical coupling aperture opening through thrust chamber pressure containment wall to admit into that hollow waveguide a feed from a power delivery fiber. Since there is no electrical power delivery electrical, insulation is not required.

Nature of coupling into hollow waveguide determines absorption length. Specifically, absorption length in hollow waveguide can be adjusted by adjusting in coupled supported mode order. Lowest order mode offers least absorption/power coupling per unit length. As order of in-coupled, supported mode increases, power deposition per unit length increases. Thus this represents a selectable factor. This amounts to coherent radiant transfer to absorbing elements, hollow waveguide optical to thermal transducers, which because of the optical characteristics admit specific design for power deposition per unit length, Optical power transfer through optical fibers is enabled similarly by the optical characteristics.

In practice, power coupling per unit length in a lossy hollow waveguide would be designed to be consistent with thermal transfer to local working fluid in flow. The objective being to design in an optimal operating condition in terms of delivered power, local working fluid flow, and thus working fluid heating. Heating is inclusive of power utilization associated with change in phase(s) if primary state of working ‘fluid’ is a liquid or solid and, post vaporization, there is also possible limited molecular dissociation.

Fact that system is of the form optical thermal, and since source fiber lasers, or laser diode arrays, are easily adjusted in power, deliverable thrust is subject to simple control by modifying, in concert, both the optical power delivered to lossy hollow waveguides and the flow of the local working fluid.

Lossy hollow waveguide optical to thermal heat conversion elements can be multiplexed in a common thrust chamber provided the driving lasers and fiber delivery paths are commensurately multiplexed (FIG. 2).

In addition, since lossy hollow waveguides are not electrical resistance elements, they are easily cross connected by a heat exchanger structure internal to the thrust chamber concerned, this increasing available surface area for thermal transfer to the working fluid. Such a heat exchanger structure integral with lossy hollow waveguides would also serve to strengthen the individual hollow waveguides by suppressing normal modes of vibration which can lead to structural failure.

A number of useful features are enabled by this approach, including power supplies/lasers which can be commercial units located distantly from the actual thruster chamber(s).

As a feature, optically heated lossy hollow waveguides, hot fingers as an alternative descriptor, can be implemented singly, or multiplexed in an array format, to scale system thrust of a single thrust chamber from very low to some more useful value (FIG. 1. and FIG. 2).

As a feature, a single hot finger in a related very small diameter thruster structure would enable very high pressure operation. This is self evident by consideration of pressure containment hoop stress and wall thickness scaling with said pressure containment diameter.

As a feature, hot finger multiplexing plus integral heat exchanger assembly should permit design for reduced in plenum flow rates while maintain optimal heating area to flow volume ratio.

As a feature, system has no requirement for electrical or thermal insulation on hot fingers as optical coupling from fiber into lossy hollow waveguide(s)/hot finger(s) is remote. That is, there is an optical assembly achieving the coupling between delivery fiber and hot finger and it is not required to be in direct physical contact with thrust chamber (FIG. 1. B).

As a feature and since the invention admits physically remote location of thrust chambers relative to power source(s), it is feasible that distributed arrays of small thrusters can be implemented. They indeed may have no more than a fiber tether to the centralized power system (FIG. 3), the fiber delivering the power over kilometers to multi ten's of kilometers if required. All that the individual thruster would require would be its attached working fluid supply, which in storage could be in solid, liquid or gas phase.

As a feature, for ease of application, deployment in vacuum conditions is to be preferred as then optically pumped interior of hollow waveguides/hot fingers is not exposed to atmospheric gases and undesired surface reactions with atmospheric components is eliminated as a concern.

As a feature, the basic optical source(s) being laser diode pumped fiber lasers and the laser diode arrays themselves, as made possible by configuration, are well developed robust long lifetime devices. The related drive electronics are low voltage and efficient.

### A BRIEF DESCRIPTION OF DRAWINGS

The accompanying drawings, which are incorporated into and form a part of the disclosure, illustrate embodiments of the invention and, together with the description, serve to explain the principles of the invention.

FIG. 1. The basic system layout, inclusive of lossy hollow waveguide/hot finger optical to thermal transducer. [A] Optical power delivery fiber. [B] Fiber to hollow waveguide/hot finger optical coupling assembly. [C] Working fluid inflow. [D] Lossy hollow waveguide/hot finger optical to thermal transducer [E] External pressure containment and thermal insulation. [F] Hot working fluid exit to de Laval nozzle entrance.

FIG. 2. The option of introducing power from multiple remote sources via fiber delivery into a unitary thrust chamber comprised of multiple fiber delivery plus hot finger elements. [A] Multiple fiber optical power delivery from multiple remotely located optical power sources. [B] Working fluid inflow. [C] A two dimensional array of hot fingers in whatever spatial arrangement is most favorable, possibly cross linked heat exchanger structure. [D] Unitary thrust chamber, pressure containment and thermal insulation structure. [E] Heated working fluid exit to de Laval nozzle entrance.

FIG. 3. This concept merely demonstrates one of the possibilities deriving from remote power delivery by optical fiber. Thrusters, in this case, conceptually used for station keeping and individual satellites concerned do not require, in each case, their own dedicated power supply.

### DETAILED DESCRIPTION OF INVENTION

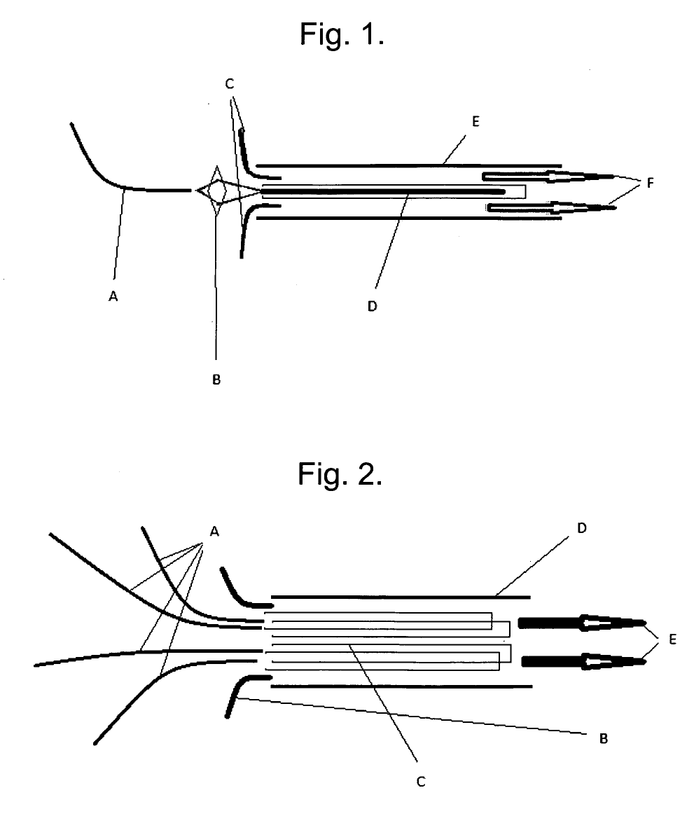

Lossy hollow waveguide(s), with optical power in-coupled from an optical fiber (FIG. 1. A, B, D & FIG. 2, A, C) or fibers, internal to a suitable structure, is the best mode contemplated by the inventor of the laser powered, optical to thermal thruster.

Lossy hollow waveguide(s) generally cylindrical of significantly greater length than diameter. Cylindrical as structurally superior in external pressure environment. (FIG. 1. D & FIG. 2. C).

Lossy hollow waveguides are constructed from any suitable high strength high melting point material of adequate optical properties at the optical wavelengths of interest. Obvious materials include Tungsten and Tantalum.

Entrance/optical in-coupling aperture of lossy hollow waveguide is open through containment wall of pressure containment structure of thrust chamber wherein it is located (FIG. 1. A, B, C & FIG. 2. A, C). Pressure containment gas flow exit a subsonic to supersonic flow conversion structure.

In vacuum operation preferred as this would void concerns of molecular ambient gas interactions with interior of lossy hollow waveguides.

Fiber to lossy hollow waveguide optical coupling assembly is located between fiber and hollow waveguide input aperture which opens through plenum pressure containment structure (FIG. 1. B). Identified units, plus fiber exit aperture, may be dynamically controlled to sustain optimal fiber to lossy hollow waveguide in-coupling regardless of thermally induced shifts or other relative spatial perturbations within reason.

In-coupling condition selected to correspond to a waveguide mode (typically higher order) which, with natural properties of hollow waveguide material results in suitable power deposition per unit length of said hollow waveguide.

Optical fiber delivery element of length required, and tolerable in terms of intrinsic fiber losses, is selected (FIG. 1. A & FIG. 2. A). This, of course absent electrical power delivery issues.

Power in coupled to delivery optical fiber from an appropriately coupled laser or array of diode lasers. In-coupling to select optimal mode or conditions for transmission.

Laser or laser diode array, optical power source, spatially remote from thrust chamber as required, constituting a centralized power node.

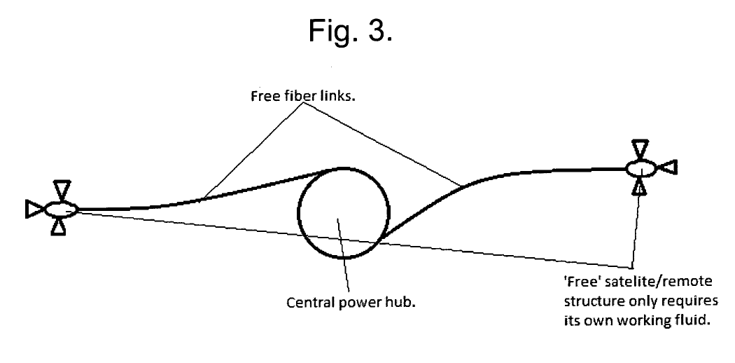

The forgoing corresponds to laser or laser diode array, or lasers or diode arrays, selecting and feeding specifically desired or multiple optical delivery fibers to multiply distributed lossy hollow waveguide microthrusters or thrusters to yield a ‘fly by wire’ control system for whatever vehicle maneuver(s) or tethered array element requiring station keeping (FIG. 3) is the object of concern.

The obvious working fluids for this kind of system would include H₂ and CH₄. In the case of CH₄, above 2000° C., the CH₄ has largely dissociated into C+2H₂ which results in a usefully small exhaust product mole mass. In the case of H₂ as a working fluid, a specific impulse of ˜950 s is possible. In the case of CH₄ this diminishes to ˜600 s which is comfortably in excess of any current chemical propulsion concept.

A microthruster may be comprised, amongst other options, of a single, or more lossy hollow waveguide(s)/hot finger(s), attached to heat exchanger assembly, a solid working “fluid” element, which by thruster internal pressure is retained in contact with hot finger plus heat exchanger assembly, thus requiring no external working fluid storage or valving.

A microthruster may be comprised, amongst other options, of a single, or more lossy hollow waveguide(s)/hot finger(s), attached to heat exchanger assembly, a liquid or gas phase working fluid element. A single lossy hollow waveguide admitting small diameter thrust chamber and thus very high pressure operation.

The forgoing description of the invention has been presented for purposes of illustration and description and is not intended to be exhaustive or to limit the invention to the precise form disclosed. Many modifications and variations are possible in the light of the above teaching. The embodiments disclosed were meant only to explain the principles of the invention and its practical application to thereby enable others skilled in the art to best use the invention in various embodiments and with various modifications suited to the particular use contemplated.

What is claimed is:

1. A fiber laser powered, optical to thermal conversion thruster comprising lossy hollow waveguide optical to thermal transducers, individual or multiplexed within a pressure and thermal containment structure, attached to integral heat exchanger if desired, optical access to hollow waveguides via through pressure chamber character of hollow waveguides, optical feed from individually matched fiber optics through independent optical coupling assemblies.

2. A fiber laser powered, optical to thermal conversion thruster, according to claim 1, wherein lossy hollow optical waveguides of high strength and high melting point material are utilized in combination with selected in coupled optical field mode selection to yield a desired power deposition per unit length.

3. A fiber laser powered, optical to thermal conversion thruster, according to claim 1, wherein the heat exchanger structures may serve the dual purpose of strengthening the hollow waveguides specifically in terms of suppression of buckling and other collapse modes.

4. A fiber laser powered, optical to thermal conversion thruster, according to claim 1, wherein the lossy hollow optical waveguide(s) are incorporated as integral internal components of a thrust chamber, comprising pressure containment structure, working fluid introduction paths, heat transfer zone where lossy hollow waveguide(s) interact with working fluid followed by de Laval type nozzle structure, or any equivalent subsonic to supersonic gas expansion structure.

5. A fiber laser powered, optical to thermal conversion thruster, according to claim 1, wherein the lossy hollow waveguide(s) entrance/optical in-coupling aperture(s) are through thrust chamber wall structure, and are matched with optical fibers for power delivery.

6. A fiber laser powered, optical to thermal conversion thruster, according to claim 1, wherein the optical coupling assembly-interface between power delivery optical fiber and lossy hollow waveguide entrance aperture is selected to couple the optical field to the hollow waveguide in a manner consistent with desired hollow waveguide mode.

7. A fiber laser powered, optical to thermal conversion thruster, according to claim 1, wherein the optical coupling interface assembly plus fiber exit aperture, may be dynamically controlled to sustain optimal fiber to lossy hollow waveguide in-coupling regardless of thermally induced shifts or other relative spatial perturbations within reason.

8. A fiber laser powered, optical to thermal conversion thruster, according to claim 1, wherein an arrangement of rigidly attached widely dispersed multiple thrusters on a single vehicle structure all powered from a central optical source power node with power delivery by optical fiber is enabled.

9. A fiber laser powered, optical to thermal conversion thruster, according to claim 1, wherein an arrangement of widely dispersed thrusters connected or tethered by no more than their associated optical power delivery fibers to a central optical source power node is enabled.

10. A fiber laser powered, optical to thermal conversion thruster, according to claim 1, wherein the system is absent the constraints inherent in directly electrically powered systems in terms of power delivery.

11. A fiber laser powered, optical to thermal conversion thruster, according to claim 1, wherein the system is absent the constraints inherent in directly electrically powered systems in terms of preferred power source proximity.

12. A fiber laser powered, optical to thermal conversion thruster, according to claim 1, wherein the system is absent the constraints inherent in directly electrically powered systems in terms of electrical isolation.

13. A fiber laser powered, optical to thermal conversion thruster, according to claim 1, wherein the system is absent the constraints inherent in directly electrically powered systems in terms of electrical isolation and thus power delivery is easily parallel multiplexed by optical fiber plus lossy hollow waveguide assemblies in a single thrust chamber assembly for scaling flexibility.

14. A fiber laser powered, optical to thermal conversion thruster, according to claim 1, wherein as it is optical-thermal conversion powered, and the optical power is derived from laser diode pumped solid state lasers or diode laser arrays efficiently coupled into simple delivery fiber, the native electrical power requirement is no more than low to moderate voltage at useful currents.

15. A fiber laser powered, optical to thermal conversion thruster, according to claim 1, wherein a central power node can be utilized to address and power distantly remote thrusters tethered by no more than a fiber cable for station keeping or other required maneuvers.

16. A fiber laser powered, optical to thermal conversion thruster, according to claim 1, wherein vehicles may be, by suitable distributed arrangement of microthrusters, or thrusters and related optical power fiber delivery systems, be maneuvered in a ‘fly by wire’ manner.

17. A fiber laser powered, optical to thermal conversion thruster, according to claim 1, wherein a microthruster may be comprised, amongst other options, of a single, or more, lossy hollow waveguide(s)/hot finger(s), attached to heat exchanger assembly, a solid working ‘fluid’ element, which by thruster internal pressure is retained in contact with hot finger plus heat exchanger assembly, thus requiring no external working fluid storage or valving.

18. A fiber laser powered, optical to thermal conversion thruster, according to claim 1, wherein a microthruster may be comprised, amongst other options, of a single lossy hollow waveguide admitting small diameter thrust chamber and thus very high pressure operation.

19. A fiber laser powered, optical to thermal conversion thruster, according to claim 1, wherein utilization of multiple optically pumped microthrusters admits optimal system net thrust control by pumping of only a selected number of available thrusters adequately to generate the thrust required but at maximal specific impulse for those thrusters pumped.

20. A fiber laser powered, optical to thermal conversion thruster, according to claim 1, wherein the obvious working fluids for this kind of system would include H₂ and CH₄, although other options also exist including solid polymers and other gases in liquid or solid phase.
